(19) United States
(12) Patent Application Publication
(10) Pub. No.: US 2011/0050460 A1
(43) Pub. Date: Mar. 3, 2011

(54) Method and apparatus for alerting mobile telephone call participants that a vehicle's driver is occupied

(76) Inventors: Glenn R. Bruns, Naperville, IL (US); John D. Hobby, Piscataway, NJ (US); Bharat Kumar, Bridgewater, NJ (US)

(21) Appl. No.: 12/584,098

(22) Filed: Aug. 31, 2009

(51) Int. Cl. G08G 1/09; H04M 1/00; B60Q 1/00

(52) U.S. Cl. 340/905; 455/575.9; 340/439

(57) ABSTRACT

A method and apparatus for improving safety when a driver of a vehicle such as an automobile is engaged in a conversation with another party (or other parties) using a mobile telecommunications device such as a cell phone. Specifically, a situation that requires an elevated attention level of the driver is automatically detected, and in response thereto, an audible alert to at least one of the remote parties to the conversation is automatically provided. The detection of a situation that requires an elevated attention level of the driver and/or the generation of the audible alert to the (one or more) remote parties may be effectuated by the driver's mobile telecommunications device (i.e., cell phone) or by a network element in the telecommunications network being used to effectuate the call.

### FIELD OF THE INVENTION

The present invention relates generally to the field of mobile telecommunications devices such as cellular telephones and more specifically to a method and apparatus for improving safety when a driver of a vehicle such as an automobile is engaged in a conversation using such a device.

### BACKGROUND OF THE INVENTION

A leading cause of automobile accidents is the use of a mobile communication device (e.g., a cell phone) while driving the vehicle. For this reason, a number of states in the U.S. have legislated a requirement that only hands-free mobile telecommunications devices may be used by the driver of an automobile. However, while the use of hands-free devices can reduce the occurrence of accidents caused by cell phone use, a complete elimination of such accidents is still not possible with the use of such devices, since it is generally believed that using any cell phone—hands-free or not—while driving a vehicle is a major source of distraction. In fact, it is generally believed that hands-free cell phone use (as mandated by law in many states) does not, in fact, make driving while using a cell phone significantly less dangerous. Moreover, many drivers often simply ignore such legislation anyway.

Although various approaches to address this problem have been proposed, all of these prior art approaches attempt to restrict or prevent the use of cell phones (or to at least prevent the use of a hand-held cell phones) by an automobile driver. Realizing that such an elimination of cell phone use (or even non-hands-free cell phone use) by automobile drivers is not likely to happen, it would clearly be advantageous to find an alternative mechanism for effectively reducing the risk of accidents when drivers are talking on a cell phone.

### SUMMARY OF THE INVENTION

The current inventors have recognized that the likely reason that using hands-free cell phones as opposed to hand-held cell phones fails to make driving while using a cell phone significantly less dangerous is because the conversation itself tends to be the primary distraction. On the other hand, conversations between an automobile driver and passengers within the same automobile do not usually tend to be particularly dangerous, possibly, as has been further recognized by the current inventors, because such conversations tend to naturally stop during critical maneuvers or other impending situations that require the driver's specific attention (i.e., in situations that require an elevated attention level of the driver).

For these reasons, the current inventors have further recognized that when the driver of an automobile is engaged in a cell phone call with one or more other parties, and a situation that requires an elevated attention level of the driver occurs, a mechanism in accordance with the principles of the present invention for providing an audible alert to the other party (or other parties) will substantially reduce the danger of using a cell phone while driving, by advantageously informing the other party or parties to the call that the driver needs to interrupt the flow of the conversation. That is, an automatically generated warning tone audible to the other party or parties will advantageously achieve many of the relative safety advantages of conversations between a driver and passengers, since the other party or parties will now know to stop talking and the driver will not have to explain why he has stopped talking (e.g., to avoid the appearance of being rude). Note that even though prior art systems which alert the driver (e.g., via an automatically generated warning tone) to such a situation do exist, these systems merely alert the driver alone (who is most likely already aware of the situation), and therefore they fail to provide any significant safety advantage (and certainly do not provide the advantageous benefits of the present invention).

Specifically, in accordance with one illustrative embodiment of the present invention, a method is provided for use in connection with a vehicle having a driver thereof, the driver using a mobile telecommunications device to engage in a conversation with one or more remote parties, the method comprising automatically detecting a situation that requires an elevated attention level of the driver; and automatically providing, in response to having detected a situation that requires an elevated attention level of the driver, an audible alert to at least one of the remote parties to the conversation.

And, in accordance with another illustrative embodiment of the present invention, a mobile communications device is provided for use in connection with a vehicle having a driver thereof, the driver using the mobile telecommunications device to engage in a conversation with one or more remote parties, the mobile communications device comprising a processor that automatically detects a situation that requires an elevated attention level of the driver; and a signal generator that automatically provides, in response to having detected a situation that requires an elevated attention level of the driver, an audible alert to the one or more remote parties to the conversation.

And also, in accordance with yet another illustrative embodiment of the present invention, a network element comprised in a telecommunications network is provided, the network element for use in connection with a mobile telecommunications device being used by a driver of a vehicle to engage in a conversation with one or more remote parties, the network element comprising a processor that automatically detects a situation that requires an elevated attention level of the driver; and a signal generator that automatically provides, in response to having detected a situation that requires an elevated attention level of the driver, an audible alert to at least one of the remote parties to the conversation.

### BRIEF DESCRIPTION OF THE DRAWINGS

FIG. 1 shows an illustrative flowchart of a method for improving safety when a driver of an automobile is engaged in a conversation using a cell phone, in accordance with an illustrative embodiment of the present invention.

FIG. 2 shows an illustrative block diagram of a portion of a cell phone adapted to improving safety when a driver of an automobile is engaged in a conversation using the cell phone, in accordance with an illustrative embodiment of the present invention.

FIG. 3 shows an illustrative block diagram of a portion of a network element of a telecommunications network adapted to improving safety when a driver of an automobile is engaged in a conversation using the cell phone, in accordance with an illustrative embodiment of the present invention.

FIG. 4 shows an illustrative dataflow diagram of a decision model for use in an illustrative method or apparatus for improving safety when a driver of an automobile is engaged in a conversation using a cell phone, in accordance with an illustrative embodiment of the present invention.

### DETAILED DESCRIPTION OF THE ILLUSTRATIVE EMBODIMENTS

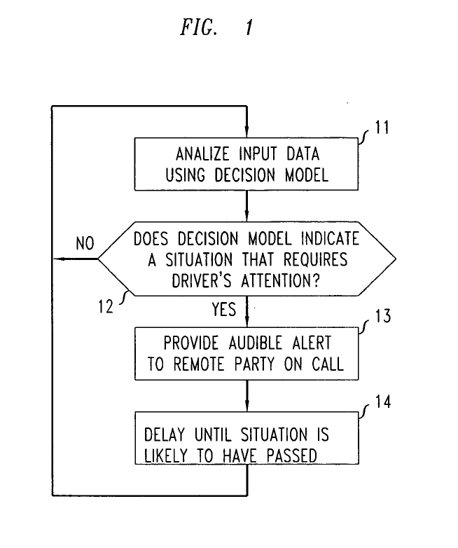

FIG. 1 shows an illustrative flowchart of a method for improving safety when a driver of an automobile is engaged in a conversation using a cell phone, in accordance with an illustrative embodiment of the present invention. The illustrative method shown in FIG. 1 iteratively analyzes various input data to determine whether there exists a situation that requires an elevated attention level of the driver, as shown in flowchart block 11. Illustratively, this analysis may be performed by a processor using a decision model. (As is fully familiar to those of ordinary skill in the art, decision models are well known algorithmic systems that evaluate one or more inputs to determine whether a specific criterion is satisfied. They are typically implemented on a computer or other processor-based device.) If, as determined by flowchart block 12 of FIG. 1, there is no such situation that requires an elevated attention level of the driver, then flow returns to flowchart block 11 to continuously analyze the input data.

If, on the other hand, flowchart block 12 determines that there is a situation that requires an elevated attention level of the driver, then an audible alert is automatically generated and provided to the remote party (or parties) to the conversation (i.e., those on the call with the driver). This, in accordance with the principles of the present invention, advantageously informs these remote parties that the conversation needs to be temporarily suspended so that the driver can give his or her utmost attention to the given situation.

In accordance with various illustrative embodiments of the present invention, such situations that require an elevated attention level of the driver may, for example, include an approach to a busy or dangerous intersection or any other location where accidents are likely, and may, for example, be determined further based on one or more of the following: the speed of the automobile; the time of day; the presence of voice stress (based, for example, on the cadence, volume, and/or pitch of speech) on the part of the driver; the detection of proximity to another vehicle using proximity sensors (if the vehicle is equipped with such sensors); camera images (e.g., cell phone camera images) of the road and/or of the driver; historical accident data; current traffic data; roadmap data; etc. Note that numerous other indicia which may be used to advantageously contribute to an analysis of whether or not a situation that requires an elevated attention level of the driver exists will be obvious to those of ordinary skill in the art.

Finally, after an audible alert is provided, the illustrative method of FIG. 1 advantageously delays for a brief period of time, until after the given situation is likely to have passed. (See flowchart block 14). This delay may, for example, comprised a predetermined and fixed amount of time, such as, for example, 10 or 15 seconds. After the delay, flow returns to flowchart block 11 to once again continuously analyze the input data.

In accordance with other illustrative embodiments of the present invention, a method for improving safety when a driver of an automobile is engaged in a conversation using a cell phone may actively detect when the given situation is likely to have passed (rather than by simply imposing a delay) before returning the flow to once again analyze the input data. For example, if the illustrative method makes use of a Global Positioning System (GPS) in making its determination that a situation that requires an elevated attention level of the driver exists, then the GPS system may also be advantageously used to determine that the geographical vicinity in which that situation exists has been passed. In particular, if “safety points” (see detailed discussion below) are being employed to identify geographical locations of interest, then, in accordance with one such illustrative embodiment of the present invention, flow may advantageously return to again analyze the input data when the GPS position information indicates that the given safety point has been passed and that the vehicle is moving away from it.

In accordance with certain illustrative embodiments of the present invention, when an audible alert is provided to the remote party (or parties) to the conversation (i.e., those on the call with the driver) in response to a determination that there is a situation that requires an elevated attention level of the driver, the driver is also advantageously notified with an audible alert. Although, in accordance with the principles of the present invention, we are most interested in notifying the other party or parties to the call, it may be advantageous that the driver be made aware that such a notification is being given to the other party or parties. In accordance with one such illustrative embodiment of the present invention, two different tones (i.e., tones having distinct audible characteristics)—one for the driver and a different one for the other party or parties—may be advantageously employed. In this manner, if both the driver and a remote party are driving (separate) vehicles and both are using a system in accordance with an illustrative embodiment of the present invention, then by distinguishing the two different tones it will advantageously be easy for each to determine the nature of the alert (i.e., an alert relating to his or her own situation or an alert relating to a situation facing one of the other parties to the call).

In addition, in accordance with one illustrative embodiment of the present invention, an audible alert may be advantageously generated in such a manner that it is included in the digitized voice data that is being sent from the driver's cell phone through the telecommunications network. (Note that it will be obvious to those of ordinary skill in the art that it is easy to add an artificially generated tone to voice data.)

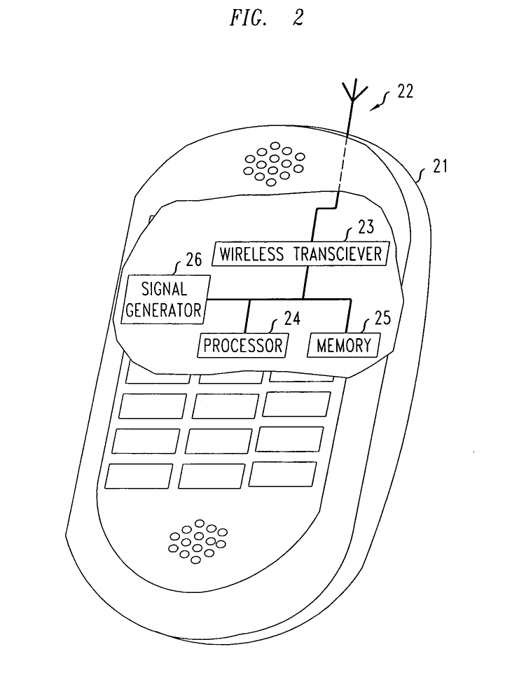

FIG. 2 shows an illustrative block diagram of a portion of a cell phone adapted to improving safety when a driver of an automobile is engaged in a conversation using the cell phone, in accordance with an illustrative embodiment of the present invention. The figure shows cell phone 21 having antenna 22, as well as several functional blocks representing a portion of the internal workings of the device. Specifically, antenna 22 is internally connected to wireless transceiver 23, which transmits and receives data via antenna 22. In addition, the device advantageously includes processor 24, memory 25, and signal generator 26, which together enable the device to effectuate some of the various illustrative embodiments of the present invention.

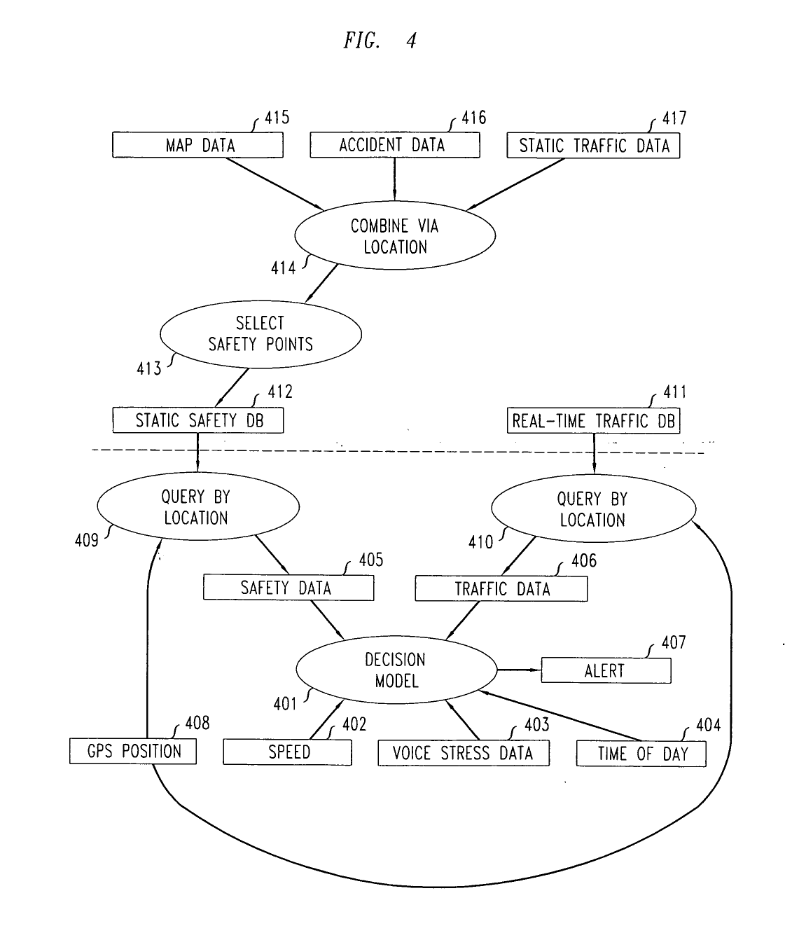

Specifically, in accordance with one illustrative mode of operation of the illustrative cell phone shown in FIG. 2, processor 24 implements an algorithmic procedure which advantageously determines that a situation that requires an elevated attention level of the driver exists. This algorithmic procedure may, for example, make use of a decision model. (See discussion above, and for more detail, see discussion below in connection with FIG. 4.) The decision model (which may, for example, be implemented with use of executable code and/or data structures) may, for example, be stored in memory 25. If a determination is made that a situation that requires an elevated attention level of the driver exists, then signal generator 26 advantageously generates an alert signal which may be provided via antenna 22 to the other party (or parties) on the call as an audible alert.

Note that in accordance with certain illustrative embodiments of the present invention, the illustrative cell phone of FIG. 2 may advantageously receive certain information from the telecommunications network to which it is connected for use by the illustrative decision model discussed above. For example, various information related to geography (e.g., “map data” as shown in FIG. 4 below), traffic statistics (e.g., “static traffic data” as shown in FIG. 4 below), current traffic data (e.g., “real-time traffic data” as shown in FIG. 4 below), and/or geographical accident likelihood (e.g., “accident data” as shown in FIG. 4 below), may be advantageously stored within and received from, directly or indirectly, the telecommunications network.

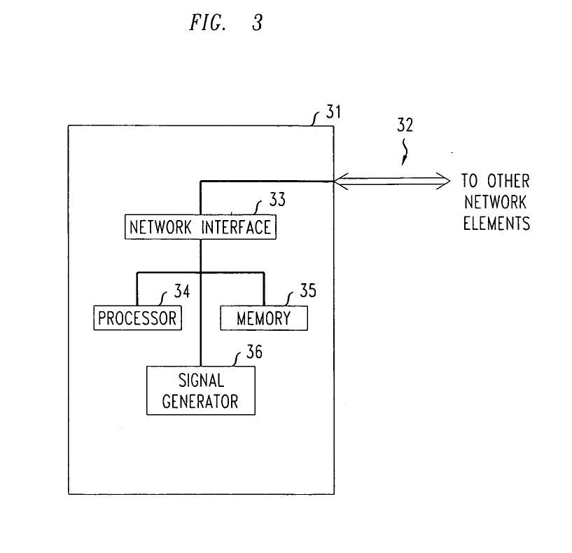

FIG. 3 shows an illustrative block diagram of a portion of a network element of a telecommunications network adapted to improving safety when a driver of an automobile is engaged in a conversation using the cell phone, in accordance with an illustrative embodiment of the present invention. The figure shows network element 31, which is interconnected via network connection 32 to other network elements in the given telecommunications network (e.g., the cellular telecommunications network to which the driver's cell phone is wirelessly connected). Specifically, network connection 32 is internally connected to network interface 33, which advantageously transmits to and receives data from other network elements via network connection 32. In addition, the device advantageously includes processor 34, memory 35, and signal generator 36, which together enable the device to effectuate some of the various illustrative embodiments of the present invention.

Specifically, in accordance with one illustrative mode of operation of the illustrative network element shown in FIG. 3, processor 34 implements an algorithmic procedure which advantageously determines that a situation that requires an elevated attention level of the driver exists. This algorithmic procedure may, for example, make use of a decision model. (See discussion above, and for more detail, see discussion below in connection with FIG. 4.) The decision model (which may, for example, be implemented with use of executable code and/or data structures) may, for example, be stored in memory 35. If a determination is made that a situation that requires an elevated attention level of the driver exists, then signal generator 36 advantageously generates an alert signal which may be provided via network connection 32 to the other party (or parties) on the call as an audible alert.

Note that in accordance with certain illustrative embodiments of the present invention, the illustrative network element of FIG. 3 may advantageously receive certain information from the given cell phone of the driver of the vehicle for use by the illustrative decision model discussed above. For example, various information related to the geographical location of the vehicle (e.g., “GPS position” as shown in FIG. 4 below and which may be determined, for example, by a GPS system), the speed of the vehicle (“speed” as shown in FIG. 4 below), a stress level of the driver (“voice stress data” as shown in FIG. 4 below), and/or the current time of day (“time of day” as shown in FIG. 4 below), may be advantageously provided to the network element, directly or indirectly, from the driver's cell phone.

FIG. 4 shows an illustrative dataflow diagram of a decision model for use in an illustrative method or apparatus for improving safety when a driver of an automobile is engaged in a conversation using a cell phone, in accordance with an illustrative embodiment of the present invention. Note that the dataflow diagram elements shown above the dashed line in the figure are relatively static dataflow elements which represent “global” information, and which may, for example, advantageously be maintained in a centralized location (e.g., on a data server which may, for example, be comprised within a telecommunications network). On the other hand, the dataflow diagram elements shown below the dashed line in the figure are dataflow elements which may advantageously be changed in real time based on “local” (with respect to the vehicle and the driver) information, and thus may, for example, be advantageously maintained “locally” (e.g., on the driver's cell phone). Moreover, in accordance with one illustrative embodiment of the present invention, the dataflow elements shown above the dashed line may be used in common by a plurality of drivers, while the dataflow elements shown below the dashed line may be applicable only to the given individual driver and vehicle and thus may be advantageously replicated individually for each driver (e.g., for each driver's cell phone).

Specifically, the illustrative dataflow diagram of FIG. 4 shows decision model 401, which may, for example, be advantageously implemented in the cell phone of the driver of the vehicle. Specifically, Decision model 401 advantageously processes a plurality of inputs and provides in response thereto a determination of whether a situation that requires an elevated attention level of the driver exists. In particular, alert 407 is advantageously produced by decision model 401 if such a situation is, in fact, determined to exist. The plurality of inputs processed by decision model 401 may, in accordance with various illustrative embodiments of the present invention, comprise a wide variety of indicia of various possible situations that require an elevated attention level of the driver. Many of these indicia will be obvious to those of ordinary skill in the art. Illustratively, however, as shown in FIG. 4, these inputs may in particular include:

(i) speed (of the vehicle) 402,

(ii) voice stress data 403,

(iii) current time of day 404,

(iv) geographical (static) safety data 405, and

(v) geographical (real-time) traffic data 406.

However, in accordance with other illustrative embodiments of the present invention, other inputs may also be provided to such an illustrative decision model, including, for example, vehicle proximity data (i.e., data representing the given vehicle's proximity to another vehicle using proximity sensors with which the vehicle is equipped), and camera image data of the road and/or of the driver (e.g., images from cell phone cameras or from cameras mounted on the vehicle) of the road and/or of the driver.

Specifically, in the illustrative example shown in FIG. 4, geographical (static) safety data 405 and geographical (real-time) traffic data 406 advantageously comprise safety and traffic data, respectively, related to the particular current geographical location of the vehicle. As such, and as shown in the figure, GPS position 408 is advantageously determined, and in response thereto, “query by location” operation 409 and “query by location” operation 410, respectively, access static safety database 412 and real-time traffic database 411 to extract the relevant corresponding data for the given current geographical location of the vehicle. Note that static safety database 412 and real-time traffic database 411 may be advantageously stored within the telecommunications network to which the driver's cell phone is connected.

In accordance with one illustrative embodiment of the present invention, “query by location” operation 409 and “query by location” operation 410 may be advantageously performed on an iterative basis. For example, geographical “safety points” may be advantageously defined (see below for an illustrative definition of “safety points”), wherein the aforementioned “query by location” operations are performed each time the current position of the vehicle, as determined by the GPS, passes (or approaches) one of these safety points. In addition, the “query by location” operations may be advantageously performed periodically (e.g., after a given time interval has passed since the last such query) as well, to ensure that there is not a long time between such checks.

The illustrative dataflow diagram of FIG. 4 also shows an illustrative dataflow of the generation of static safety database 412. In particular, map data 415, accident data 416 and static traffic data 417 are provided as inputs to “combine via location” operation 414 which advantageously consolidates this geographical data. Then, based on a predefined set of “safety points’ (see discussion above and the illustrative definition thereof below), “select safety points” operation 413 is used to advantageously generate static safety database 412, which comprises (combined) static safety data at each of the aforementioned safety points.

More specifically, the various illustrative inputs—both direct and indirect—to decision model 401 as shown in the illustrative dataflow diagram of FIG. 4 may, for example, be illustratively implemented as follows:

Map data 415 may illustratively comprise a labeled graph representative of a road map with additional records for relevant landmarks. Roads may be represented as a set of intersection-free segments, and there may be explicit records for each intersection. These may be advantageously linked together so that the intersections form the nodes of a graph and the road segments form the edges thereof. Labels may be attached to both the nodes and the edges in order to provide, for example, road names, exit numbers, and road types (e.g., local street, interstate highway, exit ramp, etc.) One illustrative example of such data is the United States Census Bureau's “TIGER” database, which is fully familiar to those of ordinary skill in the art.

Accident data 416 may illustratively comprise a set of tuples having the form (roadway-location, accident-statistic), where roadway-location may, for example, comprise the names of a pair of intersecting roadways or a roadway name together with a distance from some named intersection or landmark; and where accident-statistic may, for example, be a severity rating or a count that indicates how many accidents have occurred at the given roadway-location. (Note that one convenient way to specify a roadway-location would be via the nodes and edges in map data 415, although accident data may or may not be directly available in that form.)

Static traffic data 417 may illustratively comprise a set of tuples having the form (roadway-location, traffic-statistics), where roadway-location may be as defined above, and where traffic-statistics provide, for example, forward and reverse traffic flow levels specified in some predefined units (such as, for example, a number of vehicles per day). In accordance with one illustrative embodiment of the present invention, separate statistics may be advantageously provided for rush-hour and non-rush-hour traffic, as well as traffic statistics broken down by vehicle type (e.g., cars vs. trucks).

Static safety database 412 may illustratively comprise a database that provides the road map graph from map data 415 along with the indication of specific “safety points” and (static) safety/danger information associated therewith. As described above, each safety point may advantageously comprise a particular position along a given one of the roadway segments, which often may be at one end of the roadway segment where it meets an intersection.

Real-time traffic database 411 may illustrative comprise a set of tuples of the form (roadway-location, real-time-traffic), where roadway-location may be as defined above, and where real-time-traffic may, for example, specify current traffic conditions at the given roadway-location.

In accordance with one illustrative embodiment of the present invention, each of the direct inputs to decision model 401 may comprise a parameter having a numerical value in the range of 0 to 1, where a value of 0 may, for example, be representative of a least dangerous condition and a value of 1 may, for example, be representative of a most dangerous condition. Then, also in accordance with one illustrative embodiment of the present invention, decision model 401 may advantageously produce a consolidated (i.e., combined) value representative of the overall level of dangerousness, which may also illustratively comprise a value in the range of 0 to 1 (with, for example, 0 representing a least dangerous level and 1 representing a most dangerous level). Finally, alert 407 may be advantageously produced if (and only if) the value produced by decision model 401 is greater than a given, predetermined threshold value (which may illustratively be set equal to 0.5).

In accordance with this illustrative embodiment of the present invention, the illustrative inputs to decision model 401 as shown in the illustrative dataflow diagram of FIG. 4 may, for example, be illustratively defined as follows:

Safety data 405 illustratively comprises a number between 0 and 1 (as described above) which indicates the safety/danger level (with 0 representing the lowest level of danger and 1 representing the highest level of danger) at the current location of the vehicle (see below for the discussion of “query by location” operation 409). In addition, weighting factors may be advantageously included in safety data 405 (or obtained elsewhere) in order to indicate the degree to which safety at this location may be affected by other indicia such as, for example, voice stress of the driver, the time of day, the speed of the vehicle, and/or the current traffic on each roadway near the current safety point.

Traffic data 406 illustratively comprises a number between 0 and 1 (as described above) which indicates the congestion level (with 0 representing the lowest level of congestion and 1 representing the highest level of congestion). Illustratively, there is one such number for each roadway at or near the current safety point. (Note that, illustratively, safety points are advantageously most often located at intersections.)

GPS position 408 illustratively comprises a pair of numbers representing, for example, a longitude and a latitude representative of the current location of the vehicle. Longitude may, for example, comprise a number between −180 and 180, while latitude may, for example, comprise a number between −90 and 90. (Note that the altitude typically provided by a GPS system is advantageously not used.) GPS position 408 may also comprise a GPS velocity vector.

Speed 402 illustratively comprises a number that gives both the speed of the vehicle and the direction of travel along the given roadway. (The speed may be, for example, 50 MPH or −50 MPH, where the sign represents the direction of travel.) Note that raw GPS data typically provides a velocity vector which may easily be converted into a speed forward or backward along the given roadway.

Voice stress data 403 illustratively comprises a number between 0 and 1, where 1 is representative of indicia indicating a highly stressful voice (i.e., the highest level of stress) and 0 is representative of indicia of a calm voice (i.e., the lowest level of stress).

Time of day 404 illustratively comprises a number representative of the current time which may, for example, be specified in hours and minutes (e.g., ranging from 00:00 to 23:59, for example).

Alert 407 illustratively comprises a true or false value, indicating whether a situation that requires an elevated attention level of the driver exists, and thereby indicating whether an audible alert should be issued to the remote party (or parties) to the conversation prior to reaching the current safety point.

The following illustrative “operations” as shown in the illustrative dataflow diagram of FIG. 4 may, for example, be performed in accordance with the following procedures:

“Combine via location” operation 414 illustratively combines map data 415, accident data 416, and static traffic data 417, by advantageously identifying common locations (i.e., roads, landmarks, etc.) in the various database inputs. In particular, note that different data sources may use different names for roadways, and they may refer to positions along a given road in terms of landmarks that can be named in various ways. Such naming differences are generally systematic in nature and can typically be handled (i.e., converted) automatically with use of look-up tables. The implementation of such conversions and/or look-up tables will be obvious to those of ordinary skill in the art. In some cases, and in accordance with one illustrative embodiment of the present invention, some limited human intervention may be advantageously employed as well.

“Select safety points” operation 413 illustratively identifies the set of safety points which will be employed (see discussion above), and generates static safety database 412 based on those identified safety points. Note that map data 415 illustratively provides intersections and specifies which of these intersections involve major roadways or ramps meeting interstate highways. Crossing or merging onto a high traffic roadway (as determined, for example, by the static traffic data) advantageously produces a safety point. It may also be advantageous to look for roadways that lead to high traffic landmarks such as, for example, airports or shopping centers. Such landmarks may advantageously be used to effect the safety value and the associated weighting factors. Illustratively, accident data and static traffic data may be used as additional inputs when computing the safety value and the weighting factors. Numerous ways to take these various factors into account may be employed in accordance with various illustrative embodiments of the present invention and will be obvious to those of ordinary skill in the art.

“Query by location” operation 409 illustratively takes as input a GPS position (i.e., longitude and latitude) and a GPS velocity vector (advantageously provided from GPS position 408). Illustratively, the output of “query by location” operation 409 comprises a database record representative of static safety data at the “current” safety point (e.g., a safety point that, according to the GPS data, is being approached by the driver). In accordance with one illustrative embodiment of the present invention, this may be advantageously accomplished with use of a quad tree data structure, which is fully familiar to those of ordinary skill in the art. Such a data structure advantageously speeds up the process of scanning the database for a safety point near the GPS position provided.

“Query by location” operation 410 illustratively takes as input a GPS position (i.e., longitude and latitude) and a GPS velocity vector (advantageously provided from GPS position 408). Illustratively, the output of “query by location” operation 410 comprises a database record representative of (current) traffic data at the “current” safety point (e.g., a safety point that, according to the GPS data, is being approached by the driver). Again, in accordance with one illustrative embodiment of the present invention, this may be advantageously accomplished with use of a quad tree data structure.

In accordance with one illustrative embodiment of the present invention, decision model 401 advantageously takes as inputs the following values: voice stress data (VS), time of day (Ti), safety data (Sa), real-time traffic data (Tr1), traffic on an intersecting roadway (Tr2), and speed (Sp), as well as weighting factors lo1, lo2, med1, med2, hi1, and hi2, which may illustratively be provided as part of the safety data (see above). (Note that the weighting factors have been named herein based on the degree to which the input to which they are applied effects the overall result—lo1 and lo2 advantageously have a relatively low effect, med1 and med2 advantageously have an intermediate effect, and hi1 and hi2 advantageously have a relatively high effect.) And, in accordance with this illustrative embodiment of the present invention, decision model 401 advantageously produces the value “alert” as its output.

In accordance with various illustrative embodiments of the present invention, the following assumptions may also be advantageously made:

1. Danger increases linearly based on the voice stress data input, the safety data input, and the speed input. In particular, the safety data input may advantageously have the most significant effect, followed by the speed input, and then by the voice stress input.

2. Danger increases linearly with the traffic inputs. (Note that in accordance with other illustrative embodiments of the present invention, danger may increase linearly with the traffic inputs only until the traffic becomes very congested, and then, after the point of complete congestion has been passed, the danger may decrease. Although not shown in the illustrative implementation for decision model 401 shown below, various illustrative implementations of such an assumption will be obvious to those of ordinary skill in the art.)

3. The time of day input is advantageously used only for how it is likely to reflect non-traffic issues, such as, for example, driver tiredness and alcohol/drug use. Thus, for example, danger increases linearly with the time of day input, but only from 18:00 to 04:00.

Specifically, then, in accordance with one illustrative embodiment of the present invention, the following illustrative implementation for decision model 401 may be advantageously employed:

Decision-model (VS, Ti, Sa, Tr1, Tr2, Sp, lo1, lo2, med1, med2, hi1, hi2) =

// compute weighting factor (between 0 and 1) due to time of day
// using assumption 3 above (i.e., function “f” implements assumption 3)

time-factor = f(Ti)

// compute overall danger level, x

x = lo1*VS + lo2*time-factor + hi1*Sa + med1*Tr1 + med2*Tr2 + hi2*Sp

// and normalize x to a value between 0 and 1

x-norm = x/(lo1 + lo2 + hi1 + med1 + med2 + hi2)

// generate alert if (normalized) danger level is sufficiently high

if (x-norm < 0.5) alert = 0

else alert = 1.

### Addendum to the Detailed Description

The preceding merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams included herein represent conceptual views of illustrative circuitry embodying the principles of the invention. Similarly, it will be appreciated that any flow charts, flow diagrams, state transition diagrams, pseudocode, and the like represent various processes that may be substantially represented in computer readable medium and so executed by a computer or processor, whether or not such computer or processor is explicitly shown.

A person of ordinary skill in the art would readily recognize that steps of various above-described methods can be performed by programmed computers. Herein, some embodiments are also intended to cover program storage devices, e.g., digital data storage media, that are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

The functions of any elements shown in the figures, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a module that performs a specified task is intended to encompass any way of performing that task including, for example, a) a combination of circuit elements that performs that task or b) software in any form, including, therefore, firmware, microcode or the like, combined with appropriate circuitry for executing that software to perform the task. The invention as defined by such claims resides in the fact that the functionalities provided by the various recited modules are combined and brought together in the manner that the claims call for. Applicant thus regards any mechanisms that can provide those tasks as being equivalent to those shown herein. Note in particular that the use of such modules that perform a task as specified in the instant claims is specifically intended not to be deemed a “means for” performing a given function, as permitted by and interpreted in accordance with 35 U.S.C. 112, paragraph 6.

In particular and moreover, in accordance with various illustrative embodiments of the present invention, “detecting a situation that requires an elevated attention level of the driver,” as recited in certain ones of the instant claims may, for example, be effectuated by a mechanism (e.g., a processor) that directly makes such a determination (through an appropriate analysis such as, for example, by using a decision model), or may merely be effectuated by a mechanism (e.g., a processor) that receives the information that such a determination has been made. For example, as recited in claims directed to a “mobile communications device,” this mechanism may, in accordance with one illustrative embodiment of the present invention, simply be effectuated by a processor that receives the information (from some external source) that such a situation has been detected, or it may be effectuated by a processor that receives certain specific input data which it then uses to make such a determination. Similarly, as recited in claims directed to a “network element comprised in a telecommunications network,” this mechanism may, in accordance with one illustrative embodiment of the present invention, simply be effectuated by a processor that receives the information (from some external source) that such a situation has been detected, or it may be effectuated by a processor that receives certain specific input data which it then uses to make such a determination.

What is claimed is:

1. A method for use in connection with a vehicle having a driver thereof, the driver using a mobile telecommunications device to engage in a conversation with one or more remote parties, the method comprising:
automatically detecting a situation that requires an elevated attention level of the driver; and
automatically providing, in response to having detected a situation that requires an elevated attention level of the driver, an audible alert to at least one of the remote parties to the conversation.

2. The method of claim 1 further comprising automatically providing, in response to having detected a situation that requires an elevated attention level of the driver, an audible alert to the driver.

3. The method of claim 2 wherein the audible alert provided to the at least one of the remote parties to the conversation and the audible alert provided to the driver have distinct audible characteristics.

4. The method of claim 1 wherein the audible alert to the at least one of the remote parties to the conversation is provided by the mobile communications device.

5. The method of claim 1 wherein the audible alert to the at least one of the remote parties to the conversation is provided by a network element comprised in a telecommunications network, wherein the mobile telecommunications device is connected to the telecommunications network and wherein the conversation between the driver and the one or more remote parties is effectuated with use of the telecommunications network.

6. The method of claim 1 wherein the mobile communications device detects the situation that requires an elevated attention level of the driver.

7. The method of claim 1 wherein a network element comprised in a telecommunications network detects the situation that requires an elevated attention level of the driver, wherein the mobile telecommunications device is connected to the telecommunications network and wherein the conversation between the driver and the one or more remote parties is effectuated with use of the telecommunications network.

8. The method of claim 1 wherein automatically detecting a situation that requires an elevated attention level of the driver is based on a decision model having a plurality of inputs thereto, wherein the decision model processes the plurality of inputs and provides, based upon the plurality of inputs, a determination of whether or not a situation that requires an elevated attention level of the driver exists.

9. The method of claim 8 wherein the decision model comprises a linear equation and wherein each of the plurality of inputs comprises a corresponding numerical value, wherein the linear equation comprises a summation of each of the corresponding numerical values of the plurality of inputs multiplied by a corresponding weighting factor, and wherein the decision model produces an output based on the summation of the corresponding numerical values of the plurality of inputs multiplied by the corresponding weighting factors.

10. The method of claim 8 wherein the plurality of inputs to the decision model include one or more of
(i) static safety data comprising information relating a determined geographical location of the vehicle with geographical safety data associated with the determined geographical location of the vehicle, wherein the geographical safety data is extracted from a database thereof;
(ii) real-time traffic data comprising information relating a determined geographical location of the vehicle with current geographical traffic data associated with the determined geographical location of the vehicle, wherein the current geographical traffic data is extracted from a database thereof;
(iii) a determined speed of the vehicle;
(iv) a determined current time of day; and
(v) voice stress data determined based on an analysis of one or more vocal characteristics of the driver.

11. The method of claim 10 wherein the determined geographical location of the vehicle is determined with use of a Global Positioning System (GPS).

12. The method of claim 10 wherein the database of geographical safety data comprises geographical safety data at a plurality of selected geographic safety points, and wherein the database of geographical safety data has been derived based on one or more of (i) map data, (ii) accident data and (iii) static traffic data associated with each one of the selected geographic safety points.

13. A mobile communications device for use in connection with a vehicle having a driver thereof, the driver using the mobile telecommunications device to engage in a conversation with one or more remote parties, the mobile communications device comprising:
a processor that automatically detects a situation that requires an elevated attention level of the driver; and
a signal generator that automatically provides, in response to having detected a situation that requires an elevated attention level of the driver, an audible alert to the one or more remote parties to the conversation.

14. The mobile communications device of claim 13 further comprising a signal generator that automatically provides, in response to the processor having detected a situation that requires an elevated attention level of the driver, an audible alert to the driver.

15. The mobile communications device of claim 14 wherein the audible alert provided to the one or more remote parties to the conversation and the audible alert provided to the driver have distinct audible characteristics.

16. The mobile communications device of claim 13 wherein the processor automatically detects a situation that requires an elevated attention level of the driver with use of a decision model having a plurality of inputs thereto, wherein the decision model processes the plurality of inputs and provides, based upon the plurality of inputs, a determination of whether or not a situation that requires an elevated attention level of the driver exists.

17. The mobile communications device of claim 16 wherein the decision model comprises a linear equation and wherein each of the plurality of inputs comprises a corresponding numerical value, wherein the linear equation comprises a summation of each of the corresponding numerical values of the plurality of inputs multiplied by a corresponding weighting factor, and wherein the decision model produces an output based on the summation of the corresponding numerical values of the plurality of inputs multiplied by the corresponding weighting factors.

18. The mobile communications device of claim 16 wherein the plurality of inputs to the decision model include one or more of
(i) static safety data comprising information relating a determined geographical location of the vehicle with geographical safety data associated with the determined geographical location of the vehicle, wherein the geographical safety data is extracted from a database thereof;
(ii) real-time traffic data comprising information relating a determined geographical location of the vehicle with current geographical traffic data associated with the determined geographical location of the vehicle, wherein the current geographical traffic data is extracted from a database thereof;
(iii) a determined speed of the vehicle;
(iv) a determined current time of day; and
(v) voice stress data determined based on an analysis of one or more vocal characteristics of the driver.

19. The mobile communications device of claim 18 wherein the determined geographical location of the vehicle is determined with use of a Global Positioning System (GPS).

20. The mobile communications device of claim 18 wherein the database of geographical safety data comprises geographical safety data at a plurality of selected geographic safety points, and wherein the database of geographical safety data has been derived based on one or more of (i) map data, (ii) accident data and (iii) static traffic data associated with each one of the selected geographic safety points.

21. A network element comprised in a telecommunications network, the network element for use in connection with a mobile telecommunications device being used by a driver of a vehicle to engage in a conversation with one or more remote parties, the network element comprising:
a processor that automatically detects a situation that requires an elevated attention level of the driver; and
a signal generator that automatically provides, in response to having detected a situation that requires an elevated attention level of the driver, an audible alert to at least one of the remote parties to the conversation.

22. The network element of claim 21 further comprising a signal generator that automatically provides, in response to the processor having detected a situation that requires an elevated attention level of the driver, an audible alert to the driver.

23. The network element of claim 22 wherein the audible alert provided to the at least one of the remote parties to the conversation and the audible alert provided to the driver have distinct audible characteristics.

24. The network element of claim 21 wherein the processor automatically detects a situation that requires an elevated attention level of the driver with use of a decision model having a plurality of inputs thereto, wherein the decision model processes the plurality of inputs and provides, based upon the plurality of inputs, a determination of whether or not a situation that requires an elevated attention level of the driver exists.

25. The network element of claim 24 wherein the decision model comprises a linear equation and wherein each of the plurality of inputs comprises a corresponding numerical value, wherein the linear equation comprises a summation of each of the corresponding numerical values of the plurality of inputs multiplied by a corresponding weighting factor, and wherein the decision model produces an output based on the summation of the corresponding numerical values of the plurality of inputs multiplied by the corresponding weighting factors.

26. The network element of claim 24 wherein the plurality of inputs to the decision model include one or more of
(i) static safety data comprising information relating a determined geographical location of the vehicle with geographical safety data associated with the determined geographical location of the vehicle, wherein the geographical safety data is extracted from a database thereof;
(ii) real-time traffic data comprising information relating a determined geographical location of the vehicle with current geographical traffic data associated with the determined geographical location of the vehicle, wherein the current geographical traffic data is extracted from a database thereof;
(iii) a determined speed of the vehicle;
(iv) a determined current time of day; and
(v) voice stress data determined based on an analysis of one or more vocal characteristics of the driver.

27. The network element of claim 26 wherein the determined geographical location of the vehicle is determined with use of a Global Positioning System (GPS).

28. The network element of claim 26 wherein the database of geographical safety data comprises geographical safety data at a plurality of selected geographic safety points, and wherein the database of geographical safety data has been derived based on one or more of (i) map data, (ii) accident data and (iii) static traffic data associated with each one of the selected geographic safety points.
